(19) United States
(12) Patent Application Publication
(10) Pub. No.: US 2014/0307456 A1
(43) Pub. Date: Oct. 16, 2014

(54) VEHICLE LAMP

(71) Applicant: KOITO MANUFACTURING CO., LTD., Tokyo (JP)

(72) Inventors: Tetsuya Ishida, Shizuoka (JP); Kazuhiro Suzuki, Shizuoka (JP); Yuta Maruyama, Shizuoka (JP)

(73) Assignee: KOITO MANUFACTURING CO., LTD., Tokyo (JP)

(21) Appl. No.: 14/250,977

(22) Filed: Apr. 11, 2014

(30) Foreign Application Priority Data
Apr. 12, 2013 (JP) 2013-083431

(51) Int. Cl. B60Q 1/076

(52) U.S. Cl. CPC B60Q 1/076
USPC 362/513; 362/512

(57) ABSTRACT

A vehicle lamp includes a light distribution pattern control unit, a swivel control unit, a leveling control unit, and an ADB control device. The light distribution pattern control unit changes and controls a light distribution pattern of the lamp. The swivel control unit deflects and controls a lamp optical axis in right and left directions. The leveling control unit controls the lamp optical axis in up and down directions. The ADB control device drives and controls the light distribution pattern control unit, the swivel control unit, and the leveling control unit. The ADB control device is configured so that an actuator of the swivel control unit, an actuator of the leveling control unit, and drive circuit sections that drive the light distribution pattern control unit, the swivel control unit, and the leveling control unit, respectively can be incorporated therein individually.

### CROSS REFERENCE TO RELATED APPLICATION(S)

This application is based on and claims priority under 35 U.S.C. §119 to Japanese Patent Application No. 2013-83431 filed on Apr. 12, 2013, the entire contents of which are incorporated herein by reference.

### BACKGROUND

1. Technical Field

The present invention relates to a lamp suitable for use in a headlamp of a vehicle such as an automobile and, in particular, to a vehicle lamp for which ADB (Adaptive Driving Beam) control can be performed.

2. Background Art

ADB control has been proposed as a technique for improving the lighting effect for a forward area of a vehicle by using a headlamp of the vehicle and achieving light distribution that prevents glare to preceding vehicles and oncoming vehicles which are present in a forward area of the vehicle. This ADB control requires a light distribution pattern control means that controls a light distribution pattern of the light emitted by the headlamp. However, in a case where the light distribution pattern control alone is not sufficient, a swivel control means and a leveling control means that deflect and control an optical axis of the headlamp in the right and left directions and in the up and down directions respectively may be required. Thus, the light distribution pattern control means, the swivel control means, and the leveling control means may be required to be incorporated in the headlamp, which results in that the structure of the headlamp becomes complicated and a size and a weight of the headlamp are increased. Japanese Patent No. 4614347 (corresponding to US 2006/0291229 A) does not employ the ADB control, but describes that respective control means which realize the light distribution pattern control, the swivel control, and the leveling control of the headlamp is configured in the form of a single control unit and incorporated in the headlight. Thereby, as compared with a case where the respective control means are incorporated individually, the structure of the headlamp is simplified, and size reduction and weight reduction are achieved.

Further, JP 2011-159542 A (corresponding to US 2011/0188258 A) proposes that a control unit is configured so that a leveling control means and a swivel control means can be provided in a single case and the swivel control means may not provided in the case if required. Thus, if a headlamp does not require the swivel control means, a control unit in which the swivel control means is not incorporated in the case can be realized. Accordingly, the structure of the headlamp is simplified, and size reduction and weight reduction are achieved.

The light distribution pattern control means described in Japanese Patent No. 4614347 has such a configuration that a shade (a light shield plate) disposed in the headlamp is switched and moved between two different positions in order to switch light distribution between low-beam light distribution and high beam light distribution. Thus, the light distribution pattern control means may be an electromagnetism solenoid. Accordingly, the light distribution pattern control means can be configured to constitute a unit together with the swivel control means and the leveling control means as described above. However, in the ADB control, in order to form various light distribution patterns, control of the shade becomes complicated. Then, in order to realize this, it is required that an actuator of the light distribution pattern control means is configured by an electric motor. Also, a control circuit (an electronic device including a circuit board) for controlling the electric motor is required. Then, the electric motor for the light distribution pattern control in the ADB control is required to be disposed near the shade. Thus, it is difficult that the electric motor constitutes a unit together with the swivel control means and the leveling control means. As a result, it is difficult to simplify the structure of the headlamp, and to achieve size reduction and weight reduction.

Also, a shutter-type shade and a rotary-type shade have been proposed as a shade which is used as the light distribution pattern control means in the ADB control. Then, as described later, the shutter-type shade indispensably requires a swivel control means in order to perform the ADB control. However, some of the rotary-type shade does not require the swivel control means. Thus, if the swivel controls and the leveling control means are configured to constitute a unit as described in Japanese Patent No. 4614347, when the unit is applied to a headlamp employing the rotary-type shade, the unnecessary swivel control means is provided, which leads to a disadvantage against the weight reduction of the headlamp.

In technique described in JP 2011-159542 A, the leveling control means and the swivel control means are selectively provided in a single case. This is advantageous in simplifying the configuration of respective actuators for the leveling control and the swivel control. However, in order to drive these actuators, dedicated drive circuits are required individually. Also, another dedicated drive circuit is required to control a light distribution pattern. JP 2011-159542 A does not solve that these drive circuits to be provided make the configuration of the lamp complicated. In particular, control modes of a light distribution pattern, leveling, and swivel are different depending on differences in the specification of the lamp provided in the vehicle. Also, the control modes are different in accordance with differences between the right lamp and the left lamp. Thus, when dedicated drive circuits are provided in accordance with the differences in such specifications, the configuration of the drive circuit or of a control unit including the drive circuit is complicated. Further, such a configuration is not economically preferable.

### SUMMARY

One or more embodiments of the present invention provides a vehicle lamp including an ADB control device that has a unit configuration in which actuators and drive circuits of a light distribution pattern unit, a swivel unit, and a leveling unit in a lamp executing ADB control are integrated to thereby make it possible to simplify the structure of the ADB control device or of the entire structure of the lamp, reduce a size of the structure of the ADB control device or of the entire structure of the lamp, and reduce weight of the structure of the ADB control device or of the entire structure of the lamp.

According to one or more embodiments of the present invention, a vehicle lamp includes a light distribution pattern control unit, a swivel control unit, a leveling control unit, and an ADB control device. The light distribution pattern control unit changes and controls a light distribution pattern of the lamp. The swivel control unit deflects and controls a lamp optical axis in right and left directions. The leveling control unit controls the lamp optical axis in up and down directions. The ADB control device drives and controls the light distribution pattern control unit, the swivel control unit, and the leveling control unit. The ADB control device is configured so that an actuator of the swivel control unit, an actuator of the leveling control unit, and drive circuit sections that drive the light distribution pattern control unit, the swivel control unit, and the leveling control unit, respectively can be incorporated therein individually.

Also, an actuator of the light distribution pattern control unit may include a shutter-type shade or a rotary-type shade that shields a part of illumination light of the lamp, and an electric motor that drives the shade.

Also, at least one of (i) the drive circuit section of the light distribution pattern control unit, (ii) the actuator of the swivel control unit and the drive circuit section of the swivel control unit, and (iii) the actuator of the leveling control unit and the drive circuit section of the leveling control unit may be incorporated in the ADB control device.

Also, a microcomputer section that controls the respective drive circuit sections of the light distribution pattern control unit, the swivel control unit, and the leveling control unit may be incorporated in the ADB control device.

Also, the microcomputer section may store information for control of the respective drive circuit sections of the light distribution pattern control unit, the swivel control unit, and the leveling control unit in different modes, and may control the respective drive circuit sections based on the stored information.

With the above configuration, the respective actuators for light distribution pattern control, swivel control, and leveling control can be selectively incorporated in the ADB control device, the drive circuit sections which driving the respective actuators can be selectively incorporated in the ADB control device, or the ADB control device may be configured so that none of them is incorporated therein. This simplifies the structure of the ADB control device and realizes size reduction and weight reduction of the ADB control device and the lamp including the ADB control device. Also, if a controller incorporated in the ADB control device is shared in the light distribution pattern control, the swivel control, and the leveling control, further simplification, size reduction, and weight reduction of the ADB control device can be realized. Further, if the respective control units are controlled based on the information stored in the controller, a general-purpose ADB control device can be provided.

### BRIEF DESCRIPTION OF THE DRAWINGS

FIG. 1 is a schematic longitudinal section view of a headlamp according to an embodiment 1 of the present invention;

FIG. 2 is a perspective view of an external appearance of a shutter-type shade according to the embodiment 1;

FIGS. 3A to 3D are light distribution pattern diagrams according to the embodiment 1;

FIG. 4 is a plan view showing an internal arrangement structure of an ADB control device according to the embodiment 1;

FIG. 5 is a schematic longitudinal section view of a headlamp according to an embodiment 2 of the present invention;

FIG. 6 is a plan view showing an internal arrangement structure of an ADB control device according to the embodiment 2;

FIG. 7 is a perspective view of an external appearance of a rotary-type shade according to an embodiment 3;

FIG. 8 is a plan view showing an internal arrangement structure of an ADB control device according to the embodiment 3;

FIG. 9 is a diagram to describe variations of the ADB control device;

FIG. 10 is a flow chart describing an initialization operation of an ADB control device.

### DETAILED DESCRIPTION OF EMBODIMENTS

### Embodiment 1

Next, embodiments of the present invention will be described below with reference to the accompanying drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

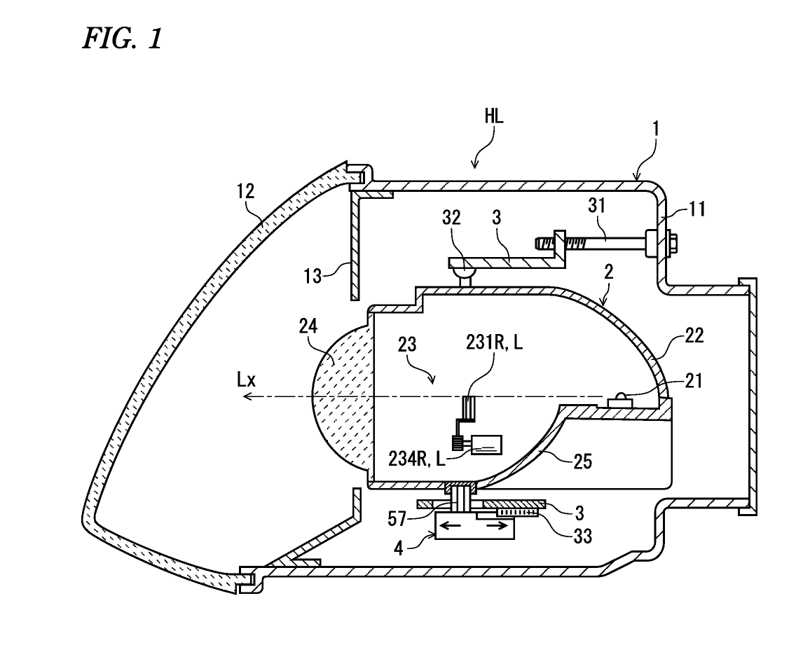

FIG. 1 is a conceptual configuration diagram of an embodiment 1 in which one embodiment is applied to a headlamp of an automobile. In the embodiment 1, a headlamp HL has such a configuration that a projector type lamp unit 2 is provided in a lamp housing 1 configured by a lamp body 11 and a transparent cover 12. ADB control is performed by controlling a light distribution pattern of light projected from the lamp unit 2 and a direction of a lamp optical axis Lx of the lamp unit 2. In the following description, the “ADB control” includes control of the light distribution pattern of the lamp unit 2 as well as deflection control in the right, left, up, and down directions for the lamp optical axis Lx of the lamp unit 2 whose light distribution pattern is controlled. Also, in order to prevent that the surroundings of the lamp unit 2 can be viewed from the outside through the transparent cover 12, a pseudo reflector (extension) 13 is provided in the lamp housing 1.

The lamp unit 2 includes a light source 21, a reflector 22, a shade 23, and a projection lens 24. The light source 21 includes a semiconductor light emitting element, such as an LED, mounted on a base member 25. The reflector 22 reflects light emitted by the light source 21, toward a forward direction in a condensed light state. The shade 23 shields a part of the condensed light. The projection lens 24 projects forward the light which is not shielded by the shade 23.

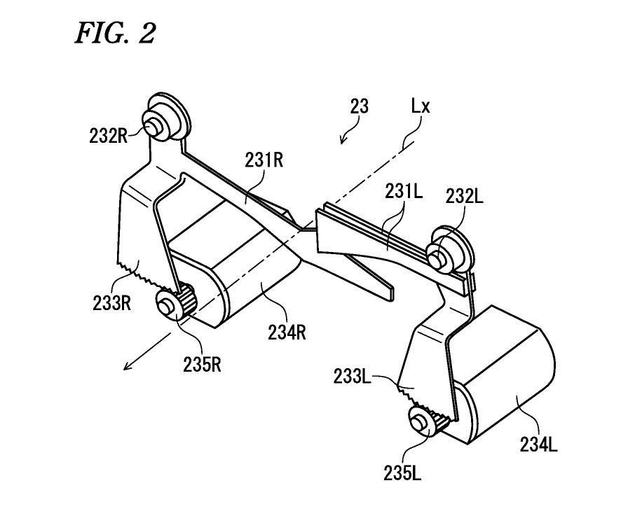

The shade 23 is a shutter-type shade in the embodiment 1. FIG. 2 is a perspective view of an external appearance of the shutter-type shade when viewed from a front and obliquely right side of the lamp unit 2. As shown in FIG. 2, the shutter-type shade 23 includes a pair of shade blades 231R and 231L that are arranged in the right and left directions relative to the lamp optical axis Lx. It is noted that the right and left directions are defined as directions viewed from a rear side of the lamp. The shade blades 231R and 231L are supported respectively by support shafts 232R and 232L so as to be tiltable in a vertical plane perpendicular to the lamp optical axis Lx. Sector gears 233R and 233L are provided integrally with the shade blades 231R and 231L, respectively. A pair of shade motors 234R and 234L are disposed on both of the right and left sides of the lamp optical axis Lx. The sector gears 233R and 233L engage with pinions 235R and 235L of the shade motors 234R and 234L. With this configuration, when each of the shade motors 234R and 234L is driven to rotate, each of the shade blades 231R and 231L rotates in a prescribed angle range in the vertical plane perpendicular to the lamp optical axis Lx. By changing rotation angle positions of the shade blades 231R and 231L independently, a shielded region of the projected light beam of the lamp unit 2 is changed, and hence the light distribution pattern of the lamp unit 2 is changed and controlled. Thus, the pair of shade motors 234R and 234L and the shutter-type shade 23 including the pair of shade blades 231R and 231L constitute a light distribution pattern actuator.

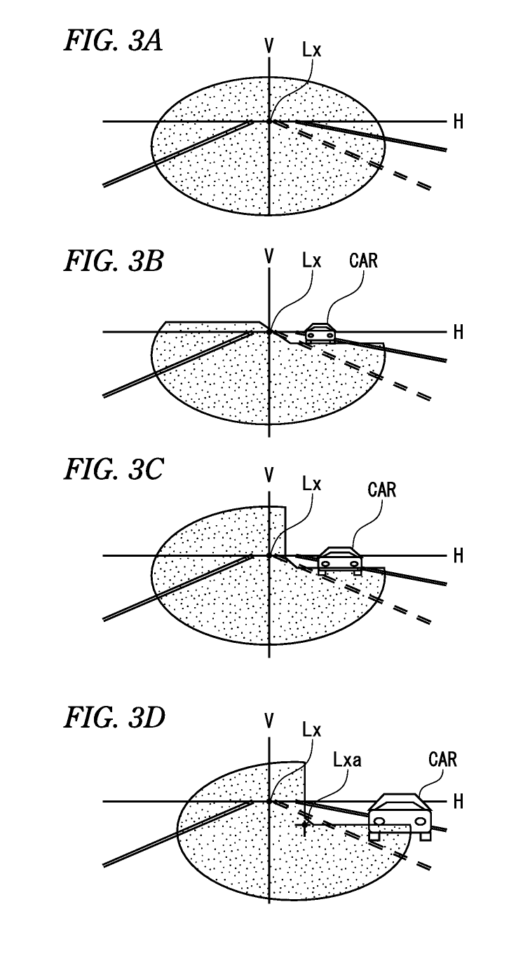

According to light distribution pattern control in the light distribution pattern actuator 23, for example, when the right and left shade blades 231R and 231L are retreated downward, there is almost no shielded region and a light distribution pattern of high beam light distribution is formed in a forward region of the automobile as shown in FIG. 3A. When both of the shade blades 231R and 231L are moved upward, an upper region is shielded by both of the shade blades 231R and 231L an a light distribution pattern of low-beam light distribution is formed in the forward region of the automobile as shown in FIG. 3B. When the right shade blade 231R alone is moved downward from this low-beam light distribution state, a light distribution pattern of so-called left side high beam light distribution is formed as shown in FIG. 3C in which a region on an oncoming lane side (right side) including a forward region of an automobile CAR (incoming vehicle) and a region in an own lane side (side of a lane in which the vehicle mounted with the lamp runs; a region on a left side) is illuminated.

As shown in FIG. 1, the lamp unit 2 is disposed in a tilting frame 3 so that a tilting position of the lamp unit 2 in the vertical up and down directions can be adjusted by an aiming screw 31. The titling frame 3 has a frame shape and is supported in the lamp housing 1. Also, the lamp unit 2 is joined to the tilting frame 3 by a ball bearing 32 provided in a shaft part of an upper end part so as to be tiltable in the up and down directions and in the horizontal right and left directions relative to the tilting frame 3. The tilting of the lamp unit 2 in the up and down directions deflects the lamp optical axis Lx in the vertical directions and thus, the leveling control can be performed. Also, the tilting of the lamp unit 2 in the right and left directions deflects the lamp optical axis Lx in the horizontal directions, and thus, the swivel control can be performed. These leveling control and swivel control cooperate with the light distribution pattern control if necessary, so as to perform the ADB control.

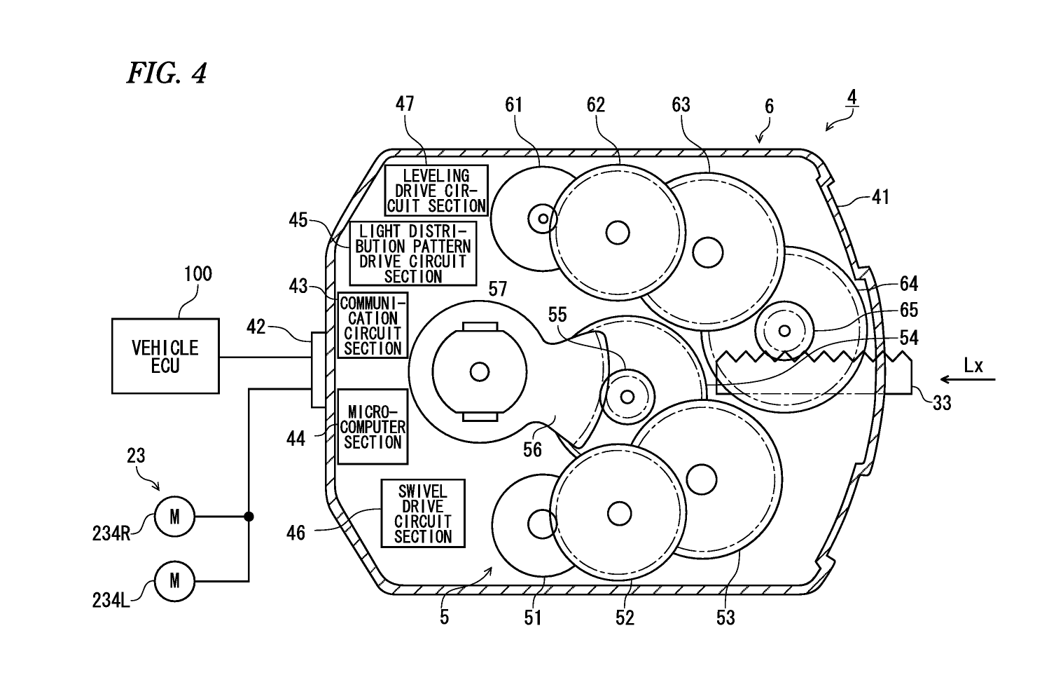

In order to realize the ADB control, an ADB control device 4 is disposed on a lower side of the tilting frame 3. The ADB control device 4 controls the operation of the light distribution pattern actuator (the shutter-type shade) 23, the tilting of the tilting frame 3 in the up and down directions, and the tilting of the lamp unit 2 in the right and left directions. FIG. 4 is a plan view conceptually showing the internal structure of the ADB control device 4. The case 41 of the ADB control device 4 is supported by a lower surface of the tilting frame 3 so as to be relatively movable to the tilting frame 3 only in the lamp optical axis Lx direction as described later. A connector 42 is provided in the case 41. The ADB control device 4 is electrically connected through the connector 42 to a vehicle ECU (Electronic Control Unit) 100 provided in a part of a vehicle body of the automobile for the purpose of control of respective portions of the automobile. Although not shown, a forward surveillance camera and other sensors are connected to the vehicle ECU 100. The vehicle ECU 100 generates a light distribution control signal for the ADB control based on information obtained by the forward surveillance camera and the other sensors and transmits the light distribution control signal to the ADB control device 4.

Also, a communication circuit section 43 and a controller (for example, a microcomputer section 44) are provided in the case 41. The communication circuit section 43 transmits and receives signals (for example, the light distribution control signal) to and from the vehicle ECU 100. The controller performs predetermined calculation based on the light distribution control signal input through the communication circuit section 43 and generates and outputs control signals for the light distribution pattern control, the swivel control, and the leveling control in the lamp unit 2. Further, in the embodiment 1, a swivel actuator 5, a leveling actuator 6, a light distribution pattern drive circuit section 45, a swivel drive circuit section 46, and a leveling drive circuit section 47 are provided in the case 41. Further, the light distribution pattern drive circuit section 45, the swivel drive circuit section 46, and the leveling drive circuit section 47 respectively controls the light distribution pattern actuator 23, the swivel actuator 5, and the leveling actuator 6 based on the control signals output from the microcomputer section 44. It is noted that the communication circuit section 43 and the microcomputer section 44 may be assembled on a single circuit board together with the light distribution pattern drive circuit section 45, the swivel drive circuit section 46, and the leveling drive circuit section 47. Alternatively, these sections may be assembled individually on separate circuit boards.

The configurations of the swivel actuator 5 and the leveling actuator 6 provided in the case 41 are basically the same as those described in JP 2011-159542 A (corresponding to US 2011/0188258 A the contents of which are incorporated herein by reference in its entirety). Thus, detailed description thereon will be omitted. As shown in FIG. 4, the swivel actuator 5 includes a swivel motor 51, a plurality of gears 52 to 55, a sector gear 56, and a rotation drive shaft 57. The swivel motor 51 is provided in the case 41. The gears 52 to 55 are linked to the swivel motor 51 so as to constitute a deceleration mechanism. The sector gear 56 is engaged with the final gear 55 of the gears 52 to 55 so as to be rotated by a predetermined angle. The rotation drive shaft 57 is provided integrally with the sector gear 56. The rotation drive shaft 57 protrudes from an upper surface of the case 41, passes upward through a hole provided in a lower part of the tilting frame 3, and is joined to a lower part of the lamp unit 2, that is, a part right under the ball bearing 32. Thus, when the swivel motor 51 is driven and rotated, the rotation drive shaft 57 is driven and rotated so that the lamp unit 2 joined to the rotation drive shaft 57 is tilted in the right and left directions and hence the swivel control is performed.

Further, as shown in FIG. 4, the leveling actuator 6 includes a leveling motor 61, a plurality of gears 62 to 64, and a pinion 65. The leveling motor 61 is provided in the case 41. The gears 62 to 64 are linked to the leveling motor 61 so as to constitute a deceleration mechanism. The pinion 65 is provided integrally with the final gear 64. As shown in FIG. 1, the pinion 65 is engaged with a rack 33 which extends in a direction parallel to the lamp optical axis Lx and which is fixed to the lower surface of the tilting frame 3. With this configuration, when the leveling motor 61 is driven and rotated, the pinion 65 is rotated about an axis in a state where the pinion 65 is engaged with the rack 33. Thus, the pinion 65 is moved, relatively to the rack 33, back and forth along the lamp optical axis Lx direction. As a result of the back and forth movement, the case 41 supporting the pinion 65 is moved back and forth in the lamp optical axis Lx direction as indicated by an arrow in FIG. 1 and thereby, the lamp unit 2 is tilted in the up and down directions and hence the leveling control is performed.

The light distribution pattern drive circuit section 45 of the ADB control device 4 is electrically connected through the connector 42 to the pair of shade motors 234R and 234L of the light distribution pattern actuator (shutter-type shade) 23. The light distribution pattern drive circuit section 45 drives and controls the light distribution pattern actuator 23. Also, the swivel drive circuit section 46 is electrically connected to the swivel motor 51, and the leveling drive circuit section 47 is electrically connected to the leveling motor 61. The drive circuit sections 46 and 47 drive and control the swivel actuator 5 and the leveling actuator 6, respectively.

In the embodiment 1, if a light distribution control signal is transmitted from the vehicle ECU 100 to the ADB control device 4 in accordance with a traveling situation of the automobile, the communication circuit section 43 of the ADB control device 4 receives the light distribution control signal, and the microcomputer section 44 outputs a control signal for the light distribution pattern control in the lamp unit 2 and a control signal for the deflection control of the lamp optical axis Lx of the lamp unit 2. Upon receipt of the control signal, the light distribution pattern drive circuit section 45 determines a light distribution pattern and drives and controls the light distribution pattern actuator 23. That is, the right and left shade motors 234R and 234L are controlled and rotated so as to control the rotation angle positions of the right and left shade blades 231R and 231L. Thereby, the light distribution pattern is controlled to be any of ones shown in FIGS. 3A to 3C.

Then, by performing the swivel control and/or the leveling control for the lamp unit 2, in accordance with a relative position change of the oncoming vehicle CAR to the vehicle on which the lamp is mounted, the ADB control is realized without glare being caused to the oncoming vehicle CAR. That is, upon receipt of the control signal, the swivel drive circuit section 46 determines a right-and-left-directional angle of the lamp optical axis Lx, that is, a swivel angle, and controls and rotates the swivel motor 51 so as to perform the swivel control for the lamp unit 2 by the swivel actuator 5. Further, upon receipt of the control signal, the leveling drive circuit section 47 determines an up-and-down-directional angle of the lamp optical axis Lx, that is, a leveling angle, and control and rotates the leveling motor 61 so as to perform the leveling control for the lamp unit 2 by the leveling actuator 6. By such control, for example, as shown in FIG. 3D, when the oncoming vehicle CAR approaches, the lamp optical axis Lx is controlled and deflected to an angular position Lxa in the lower right direction, and the illuminated light distribution of the lamp unit 2 is set to be an appropriate light distribution in which light is illuminated to a large region on the own lane side (the side of the lane in which the vehicle mounted with the lamp runs) without glare being cased to the oncoming vehicle, and the ADB control is realized.

In the embodiment 1, even if the driving source of the light distribution pattern actuator 23 is configured by the electric motor, the light distribution pattern drive circuit section 45 for driving the light distribution pattern actuator 23 is provided in the case 41. Also, the swivel drive circuit section 46 and the swivel actuator 5 as well as the leveling drive circuit section 47 and the leveling actuator 6 are provided in the case 41. These elements constitute the ADB control device 4 which is a single unit. Thus, as compared with an ADB control device having such a configuration that the respective drive circuit sections and the respective actuators are disposed individually, the structure of the ADB control device 4 is simplified. Also, the structure of the headlamp HL including the lamp unit 2 is simplified. Therefore, size reduction and weight reduction are achieved. Further, the communication circuit section 43 and the microcomputer section 44, which are incorporated in the ADB control device 4, are constructed as a common circuit section shared by the light distribution pattern drive circuit section 45, the swivel drive circuit section 46, and the leveling drive circuit section 47. Thus, further simplification, size reduction, and weight reduction of the ADB control device 4 can be realized.

### Embodiment 2

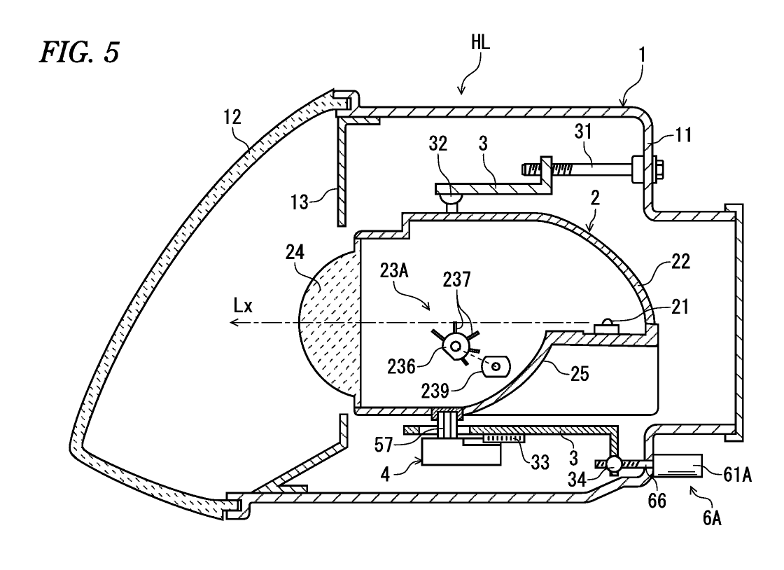

In the ADB control device 4 according to the embodiment 1, the leveling drive circuit section 47 is provided in the case 41 together with the light distribution pattern drive circuit section 45 and the swivel drive circuit section 46. Thus, the ADB control device 4 is applicable to a headlamp in which the leveling actuator 6 is provided separately from the ADB control device 4. FIG. 5 is a section view of a headlamp HL which is one example of such a configuration. It is noted that similar parts to those in FIG. 1 are designated by similar reference numerals, and description thereon will be omitted. The embodiment 2 is an example where an existing leveling actuator 6A is provided in the lamp body 11. In this configuration, the tilting frame 3 is tilted in the up and down directions by the leveling actuator 6A to thereby perform the leveling control of the lamp unit 2. The leveling actuator 6A includes a drive rod 66 moving back and forth in a direction parallel to the lamp optical axis Lx in association with the rotation of a leveling motor 61A. A tip end of the drive rod 66 is linked through a ball nut 34 to a lower end part of the tilting frame 3. Thereby, the tilting frame 3 is tilted in the up and down directions in accordance with the back and forth movement of the drive rod 66. In this case, the tilting frame 3 does not require the rack 33 of the embodiment 1. However, the rack 33 may not be removed. It is noted that while the shade of the lamp unit 2 is a rotary-type shade in FIG. 5, its configuration will be described in an embodiment 3.

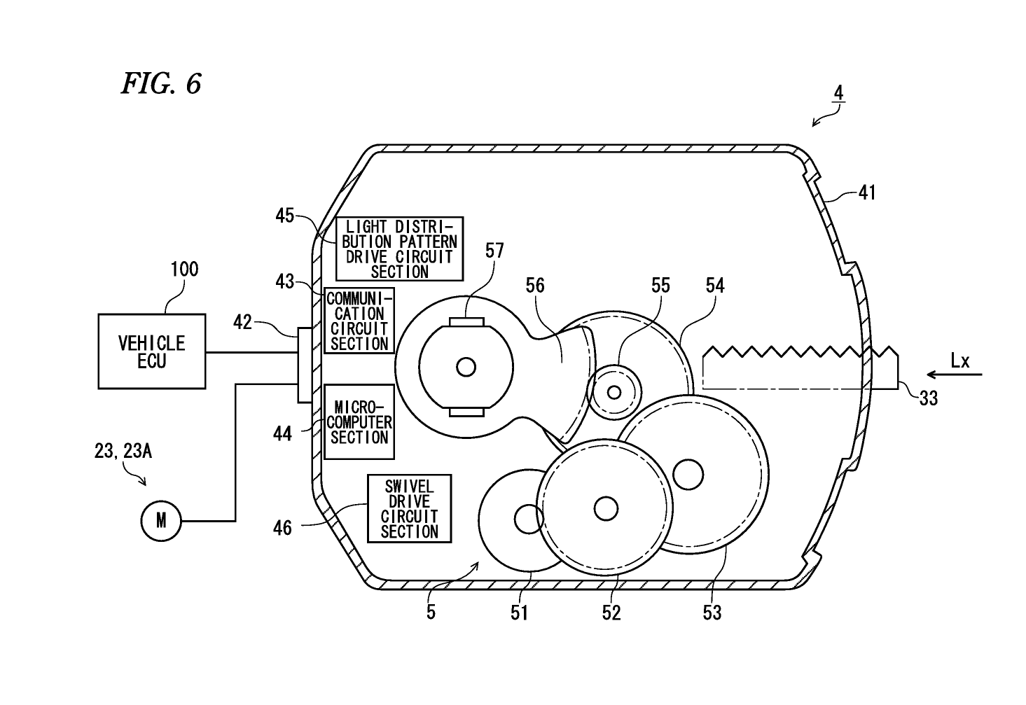

This headlamp HL including the existing leveling actuator 6A has such a configuration that no leveling actuator is incorporated in the case 41 of the ADB control device 4 as shown in FIG. 6 which is an arrangement diagram of the internal structure of the ADB control device 4. That is, the headlamp HL is configured so that the leveling motor 61, the gears 62 to 64, and the pinion 65 shown in FIG. 4 are not incorporated in the case 41. Also, if the existing leveling actuator 6A includes a dedicated leveling drive circuit section, the leveling drive circuit section 47 is not incorporated in the case 41. Furthermore, if the existing leveling actuator 6A does not include a dedicated leveling drive circuit section, the leveling drive circuit section 47 is provided in the case 41 of the ADB control device 4 so that the leveling control can be performed by using it.

In the embodiment 2, the light distribution pattern control and the swivel control in the lamp unit 2 are performed by the ADB control device 4 similarly to the embodiment 1. Also, when the leveling control is performed, the leveling drive circuit section 47 provided in the existing leveling actuator 6A is used. Thereby, the leveling drive circuit section provided in the inside of the ADB control device 4 can be omitted. Thus, similarly to the embodiment 1, the structure of the headlamp HL is simplified, and the size reduction and the weight reduction can be realized. Also, in the embodiment 2, it is not necessary to incorporate the leveling actuator 6 and the leveling drive circuit section 47 in the case 41. Thus, further weight reduction and cost reduction of the ADB control device 4 can be realized.

### Embodiment 3

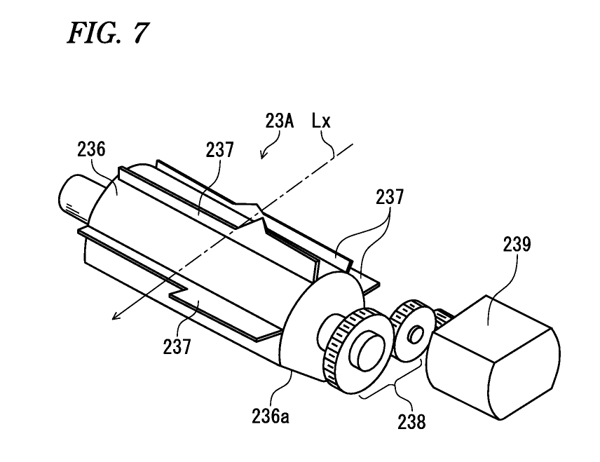

As shown in FIG. 5, one embodiment of the invention is applicable to a headlamp in which the shade of the lamp unit 2 is a rotary-type shade 23A. FIG. 7 is a perspective view of an external appearance of the rotary-type shade 23A of the lamp unit 2 according to an embodiment 3 having such a configuration when viewed from a front and obliquely upper right direction of the lamp unit 2. The rotary-type shade 23A includes a columnar shaft 236 that is oriented in the right and left directions perpendicular to the lamp optical axis Lx. A notch 236a is provided in a part of a circumference of the columnar shaft 236. Also, shade blades 237 having different shapes from each other are radially arranged at plural positions on the circumference of the columnar shaft 236. One end part of the columnar shaft 236 is linked to a shade motor 239 through a gear train 238. Then, rotation of the shade motor 239 is controlled so as to control a rotational position of the columnar shaft 236. As a result, what is moved to and located on the lamp optical axis Lx among the notch 236a and the shade blades 237 is changed to thereby change a region that shields the illumination light of the lamp unit 2, and hence the light distribution pattern of the lamp unit 2 is changed.

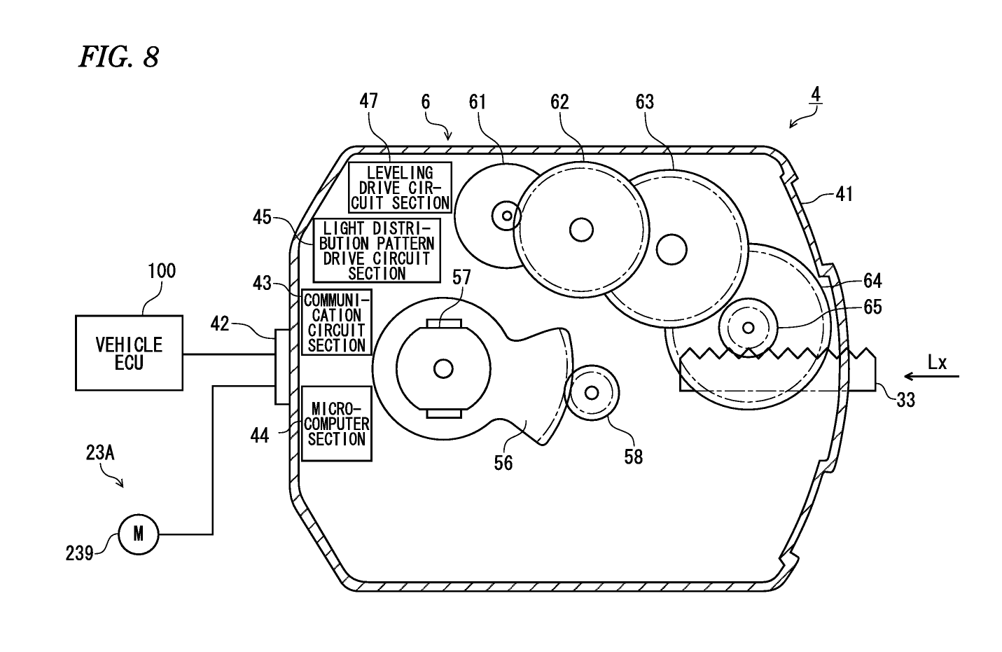

The rotary-type shade 23A has an advantage that since a large number of shade blades 237 are provided, the light distribution pattern can be controlled and changed with a wide range of varieties as compared with the shutter-type shade. Thus, it is possible not to require the swivel control of the lamp optical axis Lx even if light distribution patterns required for ADB control are to be generated. Where the swivel control is not required as such, the swivel actuator 5 is not incorporated in the case 41 of the ADB control device 4 as shown in FIG. 8 which is a conceptual plan view of the internal arrangement of the ADB control device. That is, the ADB control device 4 is configured such that the swivel motor 51 and the gears 52 to 55 shown in FIG. 4 are not incorporated in the case 41. Further, the swivel drive circuit section 46 is not incorporated in the case 41. In the Embodiment 3, the sector gear 56 and the rotation drive shaft 57 integrated with the sector gear 56 are still provided in the case 41, and a fixed gear 58 engaged with the sector gear 56 is provided. Thereby, the drive shaft 57 is joined to the lower part of the lamp unit 2 in a state where the rotation drive shaft 57 cannot be rotated.

Accordingly, similarly to the embodiments 1 and 2, in the embodiment 3, light distribution pattern control and the leveling control in the lamp unit 2 can be performed by the ADB control device 4. For light distribution pattern control, the light distribution pattern actuator is configured by the rotary-type shade 23A as described above. Therefore, various light distribution patterns can be obtained by the light distribution pattern control alone even without the swivel control. Thus, by combining only the light distribution pattern control and the leveling control, desired ADB control can be realized. Thus, similarly to the embodiments 1 and 2, the structure of the headlamp HL is simplified, and the size reduction and the weight reduction are realized. Further, in the ADB control device 4 according to the Embodiment 3, it is not necessary to incorporate the swivel actuator and the swivel drive circuit section in the case 41. Thus, the weight reduction and cost reduction of the light distribution pattern actuator can also be achieved.

As described above in the embodiments 1 to 3, the configuration of the ADB control device is changed appropriately depending on the configuration of the headlamp, that is, whether or not the existing leveling actuator is provided and whether the shade of the lamp unit is of a shutter type or a rotary type. Thereby, the structure of the ADB control device can be simplified, and the size reduction, the weight reduction, and even the cost reduction can be realized. In particular, as described in the embodiments 1 to 3, a required ADB control device can be realized only by choosing constituent components to be incorporated in the same case 41. Therefore, the case 41 and the constituent components can be communized, which is an advantageous in parts management.

Here, the embodiment 1 has been described as an example where the shade is a shutter-type shade. However, even in the case of a rotary-type shade, the swivel control may be performed. Thus, the ADB control device according to the embodiment 1 may be applied to the rotary-type shade. That is, the rotary-type shade may be driven by using an ADB control device in which a swivel actuator and a leveling actuator are incorporated, to thereby perform the ADB control. Also, the ADB control not requiring a leveling actuator can be performed. Thus, in this case, an ADB control device may be configured so that a swivel actuator alone is incorporated therein. Further, as for the drive circuit sections for light distribution pattern, swiveling, and leveling, only necessary drive circuit sections may be incorporated in the ADB control device.

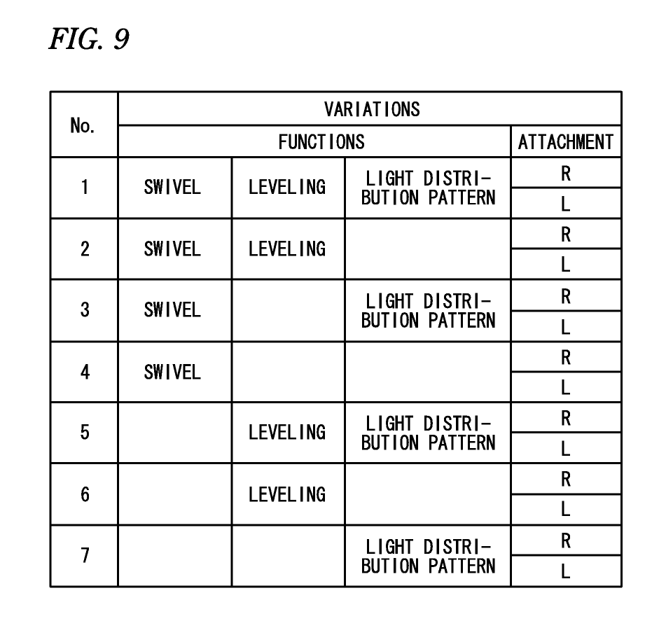

In the ADB control device according to one or more of the embodiments described above, control modes which are different variations from each other as shown in a variation table of FIG. 9 can be used. FIG. 9 shows combinations of control of swiveling, leveling, and light distribution pattern in the respective variations indicated by numbers 1 to 7. Further, in some variations, the swivel control, the leveling control, and the light distribution pattern control of the lamp unit are different depending on differences between the right headlamp (R) and the left headlamp (L). In order to deal with such different variations, a dedicated swivel drive circuit section, a dedicated leveling drive circuit section, and a dedicated light distribution pattern drive circuit section may be fabricated, and these may be selectively combined and incorporated in the ADB control device. However, this causes types of the drive circuit sections or types of the ADB control device incorporating these are increased, and manufacturing and management of the ADB control devices would be complicated.

Thus, as can be seen from the above description, in the ADB control device 4 according to one or more of the above embodiments, the communication circuit section 43 and the microcomputer section 44 have common configurations to the respective embodiments irrespective of differences in the configuration of the ADB control device. Thus, the microcomputer section 44 allows the swivel drive circuit section 46, the leveling drive circuit section 47, and the light distribution pattern drive circuit section 45 to be general-purpose ones. That is, the swivel drive circuit section 46, the leveling drive circuit section 47, and the light distribution pattern drive circuit section 45 store programs for basic controls of respective driving operations, but does not store programs for controls corresponding to the respective variations. On the other hand, in the microcomputer section 44, a read-only storage such as a ROM stores various programs for the controls corresponding to the respective variations of the swivel control, the leveling control, and the light distribution pattern control. Also, the microcomputer section 44 further includes a RAM that stores a program having been read from the ROM for use in execution of the respective controls. Further, the microcomputer section 44 includes a readable/writable memory such as a flash memory. Then, information is stored that indicates (i) which one of the variation numbers 1 to 7 in the variation table shown in FIG. 9 the ADB control device corresponds to and (ii) which one of the right and left headlamps R and L the ADB control device corresponds to. The former program may be stored as a common program in the ROM of whatever microcomputer section 44 regardless of the differences between variations. However, the latter variation information is stored individually when the ADB control device is assembled.

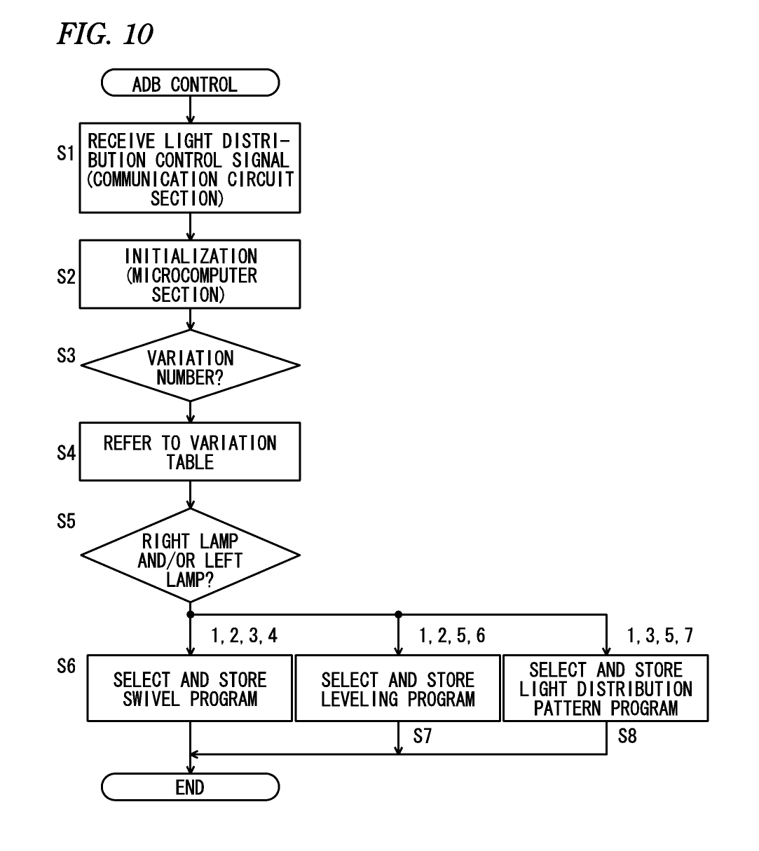

The microcomputer section 44 of the ADB control device is configured as described above. Thus, when a light distribution control signal is input from the vehicle ECU 100 to the ADB control device 4 mounted on the headlamp, the ADB control device 4 executes control shown in a flow chart of FIG. 10. That is, if the communication circuit section 43 of the ADB control device 4 receives the light distribution control signal from the vehicle ECU 100 (S1), the microcomputer section 44 executes initialization for the ADB control (S2). In this initialization, at first, the microcomputer section 44 reads from the flash memory the stored variation information (S3). Then, the microcomputer section 44 searches the variation table shown in FIG. 9 for the read variation number to recognize control to be executed (S4). That is, if the variation number is 1, the microcomputer section 44 recognizes the swivel control, the leveling control, and the light distribution pattern control as controls to be executed. Further, the microcomputer section 44 recognizes as to which of the right headlamp, the left headlamp, or both of the right and the left headlamps a headlamp to be controlled is. If the variation number is 2, the microcomputer section 44 recognizes the swivel control and the leveling control as controls to be executed. Further, the microcomputer section 44 recognizes which of the right headlamp, the left headlamp, or both of the right and the left headlamps a headlamp to be controlled is (S5). In the case of each of the variation numbers 3 to 7, similar recognition is performed.

Then, if the swivel control is to be executed fort the right and left headlamps, the microcomputer section 44 selects and reads a program of the swivel control from the ROM based on the recognition result corresponding to any of the variation numbers 1 to 7 and then stores the program in the RAM (S6). If the swivel control is not to be executed, the microcomputer section 44 does not store the program of the swivel control in the RAM. Similarly, if the leveling control is to be executed for the right and left headlamps, the microcomputer section 44 reads a program of the leveling control from the ROM and then stores it in the RAM (S7). Further, if the light distribution pattern control is to be executed for the right and left headlamps, the microcomputer section 44 reads a program of the light distribution pattern control from the ROM and then stores it in the RAM (S8). As a result of the series of processes, the initialization is completed.

If during the initialization, the microcomputer section 44 selects a program that causes the ADB control device 4 to execute one or more of the respective controls of leveling, swiveling, and light distribution pattern and stores in the RAM in the manner described above, upon receipt of a timing signal for the ADB control from the vehicle ECU 100, the microcomputer section 44 drives and controls the respective drive circuit sections and the respective actuators for swiveling, leveling, and light distribution pattern in the right and left headlamps so as to execute required ones of the swivel control, the leveling control, and the light distribution pattern control based on the control programs stored in the RAM, to thereby execute the ADB control. Further, as described above, the drive circuit sections or the ADB control device 4 is configured to be general-purpose ones. This permits seven types of ADB control corresponding to the variation numbers 1 to 7 or fourteen types of ADB control if distinction of the right and left headlamps is taken into consideration. Thus, even if devices corresponding to respective types of ADB control are not manufactured, manufacturing of a single type of the ADB control device can deal with ADB control of 14 different modes. This simplifies manufacturing and management of the ADB control device.

The configurations of the shutter-type shade and the rotary-type shade each of which serves as an actuator of a light distribution pattern control unit are not limited to those described in the embodiments 1 to 3. That is, any configuration may be adopted so long as it can do reciprocating operation or rotating operation by driving an electric motor so as to shield a part of illumination light. Also, the configurations of the swivel actuator and the leveling actuator provided in the case of the ADB control device are not limited to those in the above embodiments, but may be any configuration so long as the lamp optical axis can be tilted in the horizontal direction and the vertical direction.

The circuit section which receives a light distribution control signal and outputs a control signal for controlling the respective control units based on the received light distribution control signal is not limited to those configured by the communication section and the microcomputer section as described in the above embodiments. Such a configuration may be adopted that the circuit section is formed integrally on a single circuit board, so long as it has an equivalent function. Also, as described above, the same applies to the respective drive circuit sections of the light distribution pattern control unit, the swivel control unit, and the leveling control unit. The circuit sections may be integrally formed on a single circuit board or are formed on separate circuit boards, respectively.

The configuration of the lamp unit according to the present invention is not limited to those described in the above embodiments. The type of the light source, the shape of the reflector, and the overall configuration of the lamp unit may be modified appropriately.

One or more embodiments of the present invention is applicable to a vehicle lamp having an ADB control function of arbitrarily controlling light distribution of illumination light by means of the light distribution pattern control, the swivel control, and the leveling control.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A vehicle lamp comprising:
a light distribution pattern control unit that changes and controls a light distribution pattern of the lamp;
a swivel control unit that deflects and controls a lamp optical axis in right and left directions;
a leveling control unit that controls the lamp optical axis in up and down directions; and
an ADB control device that drives and controls the light distribution pattern control unit, the swivel control unit, and the leveling control unit,
wherein the ADB control device is configured so that an actuator of the swivel control unit, an actuator of the leveling control unit, and drive circuit sections that drive the light distribution pattern control unit, the swivel control unit, and the leveling control unit, respectively can be individually incorporated in the ADB control device.

2. The vehicle lamp according to claim 1, further comprising:
an actuator of the light distribution pattern control unit, comprising:
a shutter-type shade or a rotary-type shade that shields a part of illumination light of the lamp, and
an electric motor that drives the shade.

3. The vehicle lamp according to claim 1,
wherein at least one of the drive circuit section of the light distribution pattern control unit, the actuator of the swivel control unit and the drive circuit section of the swivel control unit, and the actuator of the leveling control unit and the drive circuit section of the leveling control unit is incorporated in the ADB control device.

4. The vehicle lamp according to claim 2,
wherein at least one of the drive circuit section of the light distribution pattern control unit, the actuator of the swivel control unit and the drive circuit section of the swivel control unit, and the actuator of the leveling control unit and the drive circuit section of the leveling control unit is incorporated in the ADB control device.

5. The vehicle lamp according to claim 1, wherein a microcomputer section that controls the respective drive circuit sections of the light distribution pattern control unit, the swivel control unit, and the leveling control unit is incorporated in the ADB control device.

6. The vehicle lamp according to claim 2, wherein a microcomputer section that controls the respective drive circuit sections of the light distribution pattern control unit, the swivel control unit, and the leveling control unit is incorporated in the ADB control device.

7. The vehicle lamp according to claim 3, wherein a microcomputer section that controls the respective drive circuit sections of the light distribution pattern control unit, the swivel control unit, and the leveling control unit is incorporated in the ADB control device.

8. The vehicle lamp according to claim 4, wherein a microcomputer section that controls the respective drive circuit sections of the light distribution pattern control unit, the swivel control unit, and the leveling control unit is incorporated in the ADB control device.

9. The vehicle lamp according to claim 5, wherein the microcomputer section stores information for control of the respective drive circuit sections of the light distribution pattern control unit, the swivel control unit, and the leveling control unit in different modes, and controls the respective drive circuit sections based on the stored information.

10. The vehicle lamp according to claim 6, wherein the microcomputer section stores information for control of the respective drive circuit sections of the light distribution pattern control unit, the swivel control unit, and the leveling control unit in different modes, and controls the respective drive circuit sections based on the stored information.

11. The vehicle lamp according to claim 7, wherein the microcomputer section stores information for control of the respective drive circuit sections of the light distribution pattern control unit, the swivel control unit, and the leveling control unit in different modes, and controls the respective drive circuit sections based on the stored information.

12. The vehicle lamp according to claim 8, wherein the microcomputer section stores information for control of the respective drive circuit sections of the light distribution pattern control unit, the swivel control unit, and the leveling control unit in different modes, and controls the respective drive circuit sections based on the stored information.
